(19) United States
(12) Patent Application Publication
(10) Pub. No.: US 2023/0220643 A1
(43) Pub. Date: Jul. 13, 2023

(54) BARRIER SYSTEM FOR PROTECTING PROPERTY FROM WIND AND FLOOD DAMAGE

(71) Applicants: Scott Alan Beers, Flemington, NJ (US); Steven Scott Little, Butler, PA (US)

(72) Inventors: Scott Alan Beers, Flemington, NJ (US); Steven Scott Little, Butler, PA (US)

(21) Appl. No.: 17/647,362

(22) Filed: Jan. 7, 2022

(51) Int. Cl. E02B 7/00; E04H 15/00; E04H 9/14

(52) U.S. Cl. CPC E02B 7/005; E04H 15/005; E04H 9/145

(57) ABSTRACT

A wind and water barrier system for the protection of property is provided, wherein the barrier system is embodied in a singular device. The systemic device includes a flexible partitioned tube, each partition fillable with water to provide a flood barrier along a supporting surface around the property. A plurality of connections points is provided along a first longitudinal segment of the flexible tube, the connection points are anchored to the supporting surface. Along a second longitudinal segment a flap interfaces with an apron and is connected thereto by way of attachment points. The apron extends from the attachment points so as to be movable between a furled storage condition and an unfurled operable condition placed or installed over the property as a wind barrier. The line of force through the unfurled planar apron may intersect the interface of the stakes, the supporting surface, and the connection points.

### BACKGROUND OF THE INVENTION

The present invention relates to the protection of property against the forces of wind and flooding, more particularly, a system for the protection of buildings from wind and flood damage, wherein the system embodies a device combining a flood barrier and a wind barrier.

During the course of a hurricane buildings are subjected to 100+ mile per hour winds and flooding due to storm surges and torrential rainfall. In the property protection market space, there are pre-existing solutions. For example, U.S. Pat. No. 8,505,263 describes inflatable cushions to protect frangible surfaces. Another example is rubber aqua dams which are filled with water to protect against storm surges. First, the inflatable cushions do not protect house from winds which are strong enough to destroy the building nor do they protect against flooding. And the aqua dams do not protect against wind or flooding due to rainfall.

As can be seen, there is a need for a system for the protection of buildings from wind and flood damage, wherein the system embodies a singular systemic device that combines a flood barrier and a wind barrier that work in concert and synergistically.

The systemic device provides a first component, a water-filled water-tight dam, placed along the property's supporting surface as a water barrier to storm surges, wherein the water-tight dam also acts as an anchor for a second component, an air-filled apron made of waterproof material that is draped over the property, thereby providing protection for the property against destructive winds, debris, torrential rainfall, etc. Simply put, the water barrier shields the property at the ground level, while the wind barrier shields the property above the water barrier. The two to four feet in girth water barrier dam may be staked to the ground through connection points. The water dam provides separate attachment points for the wind barrier apron, anchoring the apron along the perimeter of the system, wherein a systemic main stanchion and operatively associated tension members provide structural support for the apron at a centrally disposed point of the overall shelter.

In sum, the present invention simultaneously protects property from flooding and 100+ mile per hour winds; no other singular device offers total protection from both threats.

### SUMMARY OF THE INVENTION

In one aspect of the present invention, a barrier system for protecting a property from wind and flood, the barrier system includes the following: a flexible tube; a first longitudinal segment along the flexible tube; a plurality of connection points extending from the first longitudinal segment; a second longitudinal segment along the flexible tube, wherein the first and second longitudinal segments are in parallel relationship; and an apron connected along the second longitudinal segment in such a way that during use the apron extends away from the plurality of connection points.

In another aspect of the present invention, the barrier system, wherein the flexible tube extends a distance sufficient to encircle the property; including a stake associated with each connection point, wherein the flexible tube includes a plurality of more water-tight compartments, wherein each attachment point includes a flap extending from the second longitudinal segment, wherein each attachment point includes two aligned grommets, one grommet through the apron and the other grommet through the flap, wherein each attachment point includes stitching interconnecting the flap and the apron, wherein each attachment point includes removable connectors, wherein the first and second longitudinal segments are spaced apart from each other that a tensile force through the apron is generally colinear with an interface of each stake and respective connection point.

In yet another aspect of the present invention, the barrier system further includes at least one stanchion extending from the property and engaging the apron in an unfurled condition over the property; and tension members connecting the at least one stanchion and a supporting surface.

These and other features, aspects and advantages of the present invention will become better understood with reference to the following drawings, description and claims.

### BRIEF DESCRIPTION OF THE DRAWINGS

FIG. 1 is an elevation view of an exemplary embodiment of the present invention.

FIG. 2 is a top plan view of an exemplary embodiment of the present invention, illustrating the present invention in use.

FIG. 3 is a detailed perspective cross-sectional view of an exemplary embodiment of the present invention, indicated by line 3-3 of FIG. 2.

FIG. 3A is a detailed exploded perspective cross-sectional view of an exemplary embodiment of the present invention, indicated by line 3A-3A of FIG. 3.

FIG. 3B is a detailed exploded perspective cross-sectional view of an exemplary embodiment of the present invention, similar to FIG. 3A.

FIG. 3C is a detailed exploded perspective cross-sectional view of an exemplary embodiment of the present invention, similar to FIG. 3A.

FIG. 4 is a detailed front elevation view of an exemplary embodiment of the present invention, indicated by line 4-4 of FIG. 1.

FIG. 5 is a detailed side elevation view of an exemplary embodiment of the present invention.

FIG. 6 is a detailed perspective cross-sectional view of an exemplary embodiment of the present invention, illustrating a tension member 24 connecting to the flexible tube 18.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a wind and water barrier system for the protection of property, wherein the barrier system is embodied in a singular device. The systemic device includes a flexible partitioned tube wherein the tubular partitions are filled with water to provide a flood barrier along a supporting surface around the property. A plurality of connections points is provided along a first longitudinal segment of the flexible tube, the connection points are anchored to the supporting surface. Along a second longitudinal segment a flap interfaces with an apron and is connected thereto by way of attachment points. The apron extends from the attachment points so as to be movable between a furled storage condition and an unfurled condition placed or installed over the property as a wind barrier. The line of force through the unfurled planar apron may intersect the interface of the stakes, the supporting surface and the connection points.

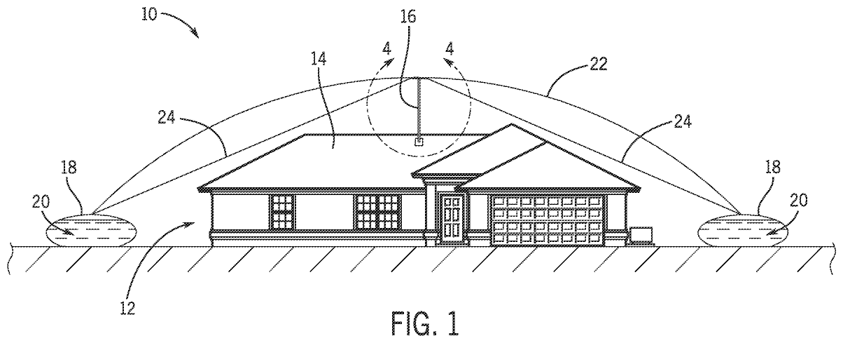

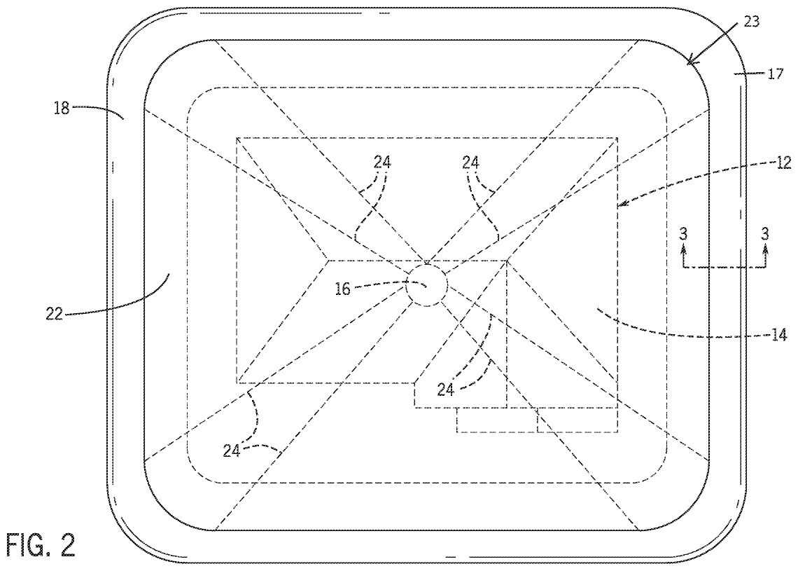

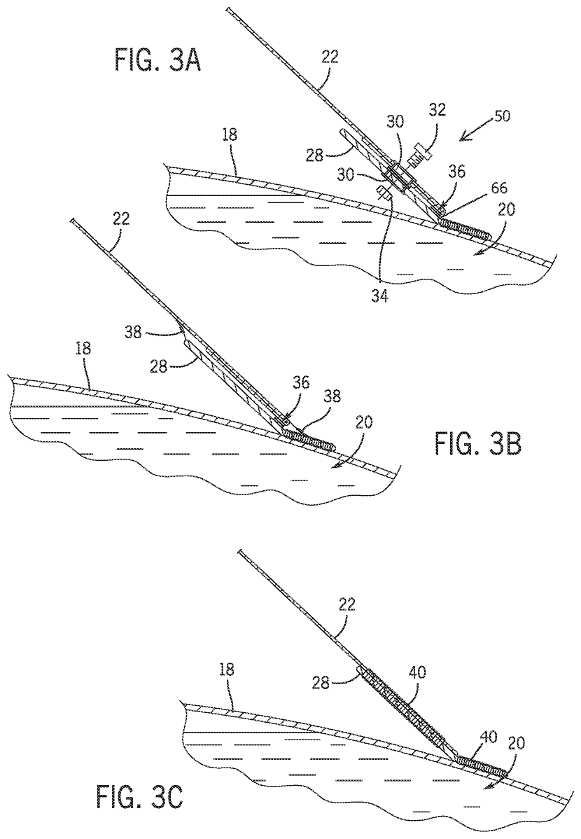

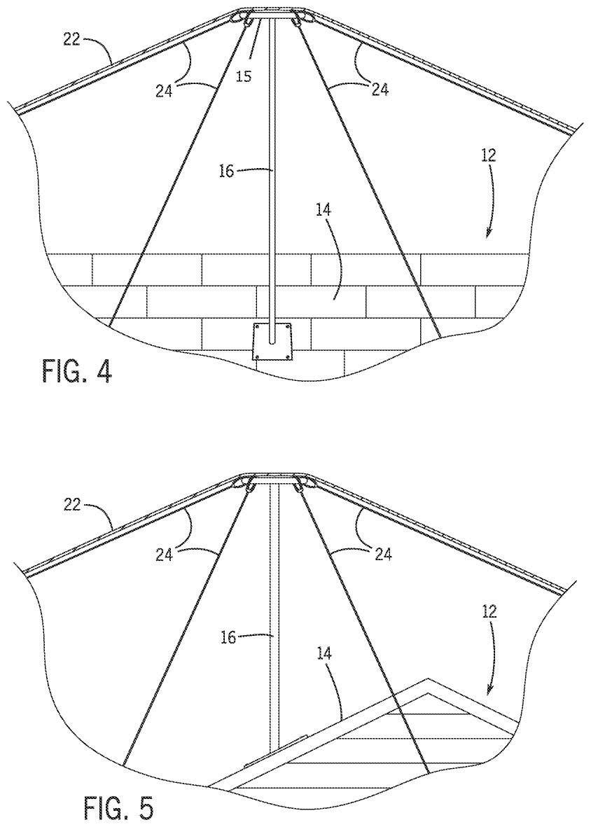

Referring now to FIGS. 1 through 6, the present invention may include a property protection system 10 for property 12. Though the Figures illustrate the property 12 as real property, it should be understood that the property 12 that can be protected by the property protection system 10 may include chattel and other personal property, as well as residential and commercial structures.

The property protection system 10 embodies a systemic device 100 embodying a water barrier 17 and a wind barrier 23. The water barrier 17 may include a flexible tube 18 filled with fluid 20 so that the shape of the fluid-filled tube 18 conforms to the shape of its supporting surface, thereby providing a water-tight barrier at a supporting surface, even if that supporting surface is uneven terrain. The flexible tube 18 may be made of rubber, silicone or various plasticize and/or polymeric materials enabling the surface-conforming properties disclosed herein.

The flexible tube 18 defines a fluid-tight cavity fillable with a fluid 20, such as water, that is retained in the flexible tube 18. The flexible tube 18 includes a plurality of compartments so that if there is a puncture in one compartment, the remaining compartment are unaffected. The fluid-filled flexible tube 18 may have an ellipsoid cross-section. The diameter or girth of the fluid-filled flexible tube 18 may range between two to twenty-four feet. For instance, the fluid-filled flexible tube 18 diameter illustrated in FIG. 1 is approximately four-and-a-half feet in height and is about ten feet in width. The fluid-filled flexible tube 18 may be designed to protect against a ten-foot flood, and so would be a approximately over twenty-three feet in width.

Along a first longitudinal segment 56 of the flexible tube 18 a plurality of connection points 46 may be spaced apart. Each connection point 46 provides an interconnection between the flexible tube 18 and a stake 26 that can be driven in the supporting surface. The stakes 26 secure the flexible tube 18 to the supporting surface, allowing the fluid-filled flexible tube 18 to act as an anchor to the wind barrier 23.

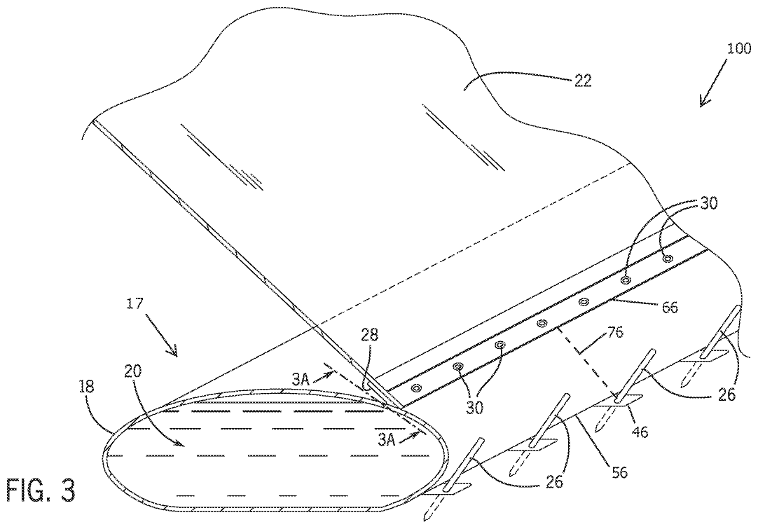

The wind barrier 23 may be a planar sheet or apron 22 of material extending tangentially from a second longitudinal segment 66 along the flexible tube 18. Along the second longitudinal segment 66, a comoulded flap 28 may be connected to the flexible tube 18. The flap 28 may interconnect the flexible tube 18 and the apron 22 by the way of a plurality of spaced apart attachment points 50. The attachment points 50 may include a grommet 30 in both the flap 28 and the apron 22, inward of the respective peripheral edges. Fasteners 32 and 34, such as bolts and nuts, may rigidly connect the aligned grommets 30, as illustrated in the FIG. 3A. In another embodiment, removable connectors 36 and 38 may also facilitate the connection of the apron 22 to the flap 28. The removable connectors 36 and 38 may be hook and loop, snaps, zippers, and all other connectors that removably connect two objects to each other. In another embodiments, stitching 40 may be used to facilitate the connection between the flap 28 and the apron 22.

The first and second longitudinal segments 56 and 66 may be parallel to each other, thereby avoiding eccentricity of relative forces imposed by the wind forces relative to the resisting force acting through the connection points 46 and the stakes 26. This linearly orientation of wind-produced force and stake-connections 26-46 reactive force aims to eliminate eccentric forces that produce translation and rotation, and thus torque. In certain if a straight line 76 were drawn coplanar with the plane that defines the apron 22, the straight line 76 would intersect the stake 26 and connection point 46 interface at the supporting surface, as illustrated in FIG. 3. The connection points 46 may be dimensioned and adapted to facilitate this collinearity. The apron 22 may be made from any material that is waterproof and windproof. The sheet of the wind barrier 22 may be inflated with air.

An additional systemic component may include one or more stanchions 16, which may be connected to an upper portion 14 of the property 12. The stanchion(s) 16 may be placed near the centroid of the unfurled apron 22, thereby acting as a pole to provide structural support to the overall shelter defined by the apron 22. A plurality of tension members 24, such as guy lines, may interconnect the stanchion(s) 16 and property's supporting surface (by way of individual stakes/anchors, thereby structurally supporting the stanchion(s) 16. Alternatively, the guy lines 24 may attach directly to the fluid-filled flexible tube 18. The stanchion 16 may have a loop 15 at a distal end thereof for facilitating the connections of the tension members 24 to the stanchion 16.

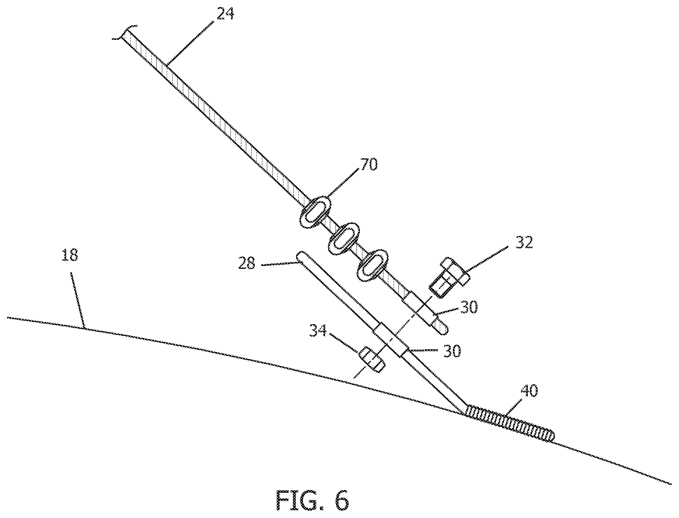

Referring the FIG. 6, the guy lines 24 may also be connected to the flap 28 that is joined to the fillable tube 18, in certain embodiments by way of stitching 40. Fasteners 32 and 34, such as bolts and nuts, may rigidly connect the flap 28 and a guy line/tension member 24 via aligned grommets 30. Adjacent the end of the tension member 24 may be wire rope clips 70 adapted to fix the loose end of the loop back to the guy line/tension member 24.

During use, the water barrier 17 provides weight and the stakes 26 provide stabilization. The conforming properties of the fluid-filled flexible tube 18 provides a seal with the ground much the way sandbags do to prevent flooding. The inflatable apron 22 is filled with pressurized air, thereby providing protection from strong winds, debris, and torrential rain. The apron 22 may be compartmentalized so that if a portion thereof is punctured the integrity of the apron 22 remains intact. The tension members 24 may guide the whole device which is draped over the property 12. The tension members 24 may also provide support for the apron 22 during high winds.

A method of using the present invention may include the following. The property protection system 10 disclosed above may be provided. Once the property 12 has been measured, the systemic device 100 may be installed over the top of the property 12 through unfurling the apron 22. Alternatively, the systemic device 100 may be installed using a crane when needed. Once the systemic device 100 is installed and unfurled the water barrier 17 is secured to the ground with hammer and stakes 26. It is then filled with water then sealed. The apron 22 and its compartment/s are then filled with air then sealed. In a storage condition, the apron 22 may be wrapped around the flexible tube 18.

As used in this application, the term “about” or “approximately” refers to a range of values within plus or minus 10% of the specified number. And the term “substantially” refers to up to 90% or more of an entirety. Recitation of ranges of values herein are not intended to be limiting, referring instead individually to any and all values falling within the range, unless otherwise indicated, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A barrier system for protecting a property from wind and flood, the barrier system comprising:
a flexible tube;
a first longitudinal segment along the flexible tube;
a plurality of connection points extending from the first longitudinal segment;
a second longitudinal segment along the flexible tube, wherein the first and second longitudinal segments are in parallel relationship; and
an apron connected along the second longitudinal segment in such a way that during use the apron extends away from the plurality of connection points.

2. The barrier system of claim 1, wherein the flexible tube extends a distance sufficient to encircle the property.

3. The barrier system of claim 1, further comprising a stake associated with each connection point.

4. The barrier system of claim 1, wherein the flexible tube includes a plurality of more water-tight compartments.

5. The barrier system of claim 1, wherein each attachment point includes a flap extending from the second longitudinal segment.

6. The barrier system of claim 5, wherein each attachment point includes two aligned grommets, one grommet through the apron and the other grommet through the flap.

7. The barrier system of claim 5, wherein each attachment point includes stitching interconnecting the flap and the apron.

8. The barrier system of claim 5, wherein each attachment point includes removable connectors.

9. The barrier system of claim 3, wherein the first and second longitudinal segments are spaced apart from each other that a tensile force through the apron is generally colinear with an interface of each stake and respective connection point.

10. The barrier system of claim 9, further comprising at least one stanchion extending from the property and engaging the apron in an unfurled condition over the property; and tension members connecting the at least one stanchion and a supporting surface.
